(19) United States
(12) Patent Application Publication
(10) Pub. No.: US 2020/0094437 A1
(43) Pub. Date: Mar. 26, 2020

(54) Multi-directional marble cutting apparatus

(71) Applicant: Siyi Chen, Weihai City (CN)

(72) Inventor: Siyi Chen, Weihai City (CN)

(21) Appl. No.: 16/695,068

(22) Filed: Nov. 25, 2019

(30) Foreign Application Priority Data
Sep. 6, 2019 (CN) 2019108433634

(51) Int. Cl. B28D 1/04

(52) U.S. Cl. CPC B28D 1/043

(57) ABSTRACT

The invention discloses a multi-directional marble cutting apparatus, which includes a machine tool. A rotary column is rotatably provided at the center of the upper end surface of the machine tool. A base is fixed at the upper end of the rotary column. A clamping cavity is provided at the center of the machine tool. A steering motor is fixed on the lower wall of the clamping cavity. The lower end of the rotating column extends into the clamping cavity and is dynamically connected to the upper end of the steering motor. A clamping device is provided on the side symmetrically, and a left-right symmetrical clamping plate is provided in the clamping device, and the clamping plates are located on the left and right sides of the rotating column.

### CROSS-REFERENCES TO RELATED APPLICATIONS

The present application claims priority from Chinese application No. 2019108433634 filed on Sep. 6, 2019 which is hereby incorporated by reference in its entirety.

### TECHNICAL FIELD

The invention relates to the technical field of marble cutting, in particular to a multi-directional marble cutting apparatus.

### BACKGROUND OF THE INVENTION

In the marble production process, large marbles need to be cut, and the extra parts at the edges need to be cut. When cutting marbles with traditional cutting devices, when adjusting the cutting position, it is necessary to carry out adjustments to the marbles, which requires large waste. Manpower and time greatly reduce the cutting efficiency. At the same time, due to manual handling, deviations in the cutting position will occur, reducing the processing quality of marble. The present invention illustrates a device capable of solving the above problems.

### CONTENT OF THE INVENTION

Technical problem: the traditional marble cutting machine needs to manually adjust the marble position to adjust the cutting position and reduce the processing efficiency. At the same time, artificially adjusting the cutting position results in deviations in the cutting position and low processing accuracy.

In order to solve the above problems, a multi-directional marble cutting device is designed in this example. The multi-directional marble cutting device in this example includes a machine tool, and the center of the upper end surface of the machine tool is rotatably provided with a rotating column, and the upper end of the rotating column A base is fixedly provided, and a clamping cavity is provided at the inner center of the machine tool. A steering motor is fixedly provided on the lower wall of the clamping cavity. The lower end of the rotating column extends into the clamping cavity and is dynamically connected to the steering motor. At the upper end, clamping devices are symmetrically arranged on the left and right sides of the rotating column in the clamping cavity, and left and right symmetrical clamping plates are provided in the clamping device, and the clamping plates are located on the left and right sides of the rotating column. On both sides, after the steering motor drives the base to rotate through the required angle through the rotating column, the clamping plate can clamp the left and right ends of the rotating column, and then increase the base during the cutting process. The left and right sides of the machine tool are provided with lifting devices. The lifting device is provided with left and right symmetrical lifting pillars. The clamping plate is connected to the lifting pillars. Narrative The plate is clamped. A cross beam is fixed at the upper end of the lifting pillar. A translation device is provided in the translation block. A translation block is provided in the translation device that can slide in the beam. A rotating device is provided on the side, and a rotating plate located on the lower side of the translation block is provided in the rotating device. A cutting device is provided on the lower side of the rotating plate, and a saw blade is provided in the cutting device.

Preferably, the translation device can drive the rotating plate to move horizontally in the left-right direction through the translation block, and at the same time, in combination with the turning of the base, rotate the cutting point directly below the beam, and then move the The saw blade is above the cutting point, and by rotating the rotating plate, the cutting direction of the saw blade is adjusted, and then marble is cut at a fixed point. When marble cutting is required, the base is rotated so that the cutting direction is The left-right direction is parallel to the beam. At this time, the rotating plate is rotated so that the cutting direction of the saw blade is the left-right direction, and then the saw blade is moved forward or backward to above the cutting line, and then the saw blade is lowered for cutting. At the same time, the translation block moves left and right to drive the saw blade to move left and right to cut. Wherein, the clamping device includes a link cavity that is symmetrically and connected to the left and right walls of the clamping cavity, and the clamping plate is symmetrically and slidably disposed in the clamping cavity. A push-pull rod located in the link cavity is hinged on an end surface of the plate remote from the rotation column, and one end of the push-pull rod remote from the clamping plate is hinge-connected to a lower end of an end of the lift pillar near the center of symmetry.

Wherein, the lifting device includes a lifting cavity symmetrically provided at the left and right ends in the machine tool and opening upward, the lifting cavity communicates with the side of the connecting rod cavity away from the clamping cavity on the same side, and the lifting pillar can be up and down A sliding screw is provided in the lifting cavity, and a lower wall of the lifting cavity is rotatably provided with a lifting screw threadedly connected to the lifting pillar. A wheeled cavity is provided on the lower side of the lifting cavity, and a lower end of the lifting screw is provided. A driven pulley is fixedly extended in the pulley cavity, and a driving pulley is rotatably provided between the driven pulleys, and a winding is arranged between the driving pulley and the driven pulley. Transmission belt. Preferably, a lifting motor is fixed in the upper wall of the pulley cavity and on the rear side of the steering motor, and the active pulley is dynamically connected to the lower end of the lifting motor.

Wherein, the translation device includes a translation cavity provided in the beam and opening downward, a translation motor is fixedly located in the right wall of the translation cavity, a translation screw is connected to the left end of the translation motor, and the translation block can be Left and right slides are arranged in the translation cavity and are screwed to the translation screw.

Wherein, the rotating device includes a turntable cavity provided on the lower side of the translation block, a turntable is rotatably provided in the turntable cavity, and a suspension column is fixed at the center of rotation of the lower end of the turntable, and the suspension The lower end of the column extends to the lower side of the translation block, and the rotating plate is fixedly disposed at the lower end of the suspension column. Preferably, a rotating electric machine is fixed in the upper wall of the turntable cavity, a lower end of the rotating electric machine is power-connected with a power shaft, and the lower end of the power shaft is fixedly connected to the center of rotation of the upper end surface of the rotating disk.

Wherein, the cutting device includes a fixing block fixedly arranged at the left end of the lower end surface of the rotating plate, and a hydraulic pump is fixed inside the fixing block. A hydraulic telescopic arm is connected to the right end of the hydraulic pump, and a right end of the hydraulic telescopic arm A moving block is fixedly provided, a cutting motor is fixedly installed in the moving block, a semi-circular dust-proof plate is fixedly located on the right end face of the moving block, and the saw blade is arranged in the dust-proof plate and is dynamically connected. At the right end of the cutting motor.

Preferably, a guide sliding cavity with an opening downward is provided in the rotating plate and on the right side of the fixed block, and a guide sliding rod is fixedly connected between the left and right walls of the guide sliding cavity. A sliding slider slidingly connected to the guide slider is provided, and the lower end of the sliding slider is fixedly connected to the upper end surface of the moving block.

The beneficial effect of the present invention is that by adjusting the position and direction of the marble and the cutting tool, the present invention can perform fixed-point and arbitrary angle cutting on any position of the marble, and can also perform linear cutting on any linear position of the marble to meet more cutting process requirements. And, when cutting, the base is clamped firmly to avoid shifting during cutting and torsion to the cutter, causing damage or cutting accidents.

### BRIEF DESCRIPTION OF THE DRAWINGS

For ease of description, the present invention is described in detail by the following specific embodiments and the accompanying drawings.

FIG. 1 is a schematic diagram of the overall structure of a multi-directional marble cutting device according to the present invention;

FIG. 2 is a schematic structural diagram of the direction “A-A” of FIG. 1;

FIG. 3 is a schematic structural diagram in a direction “B-B” of FIG. 1;

FIG. 4 is an enlarged schematic view of the structure of “C” in FIG. 1.

### DETAILED DESCRIPTION OF THE INVENTION

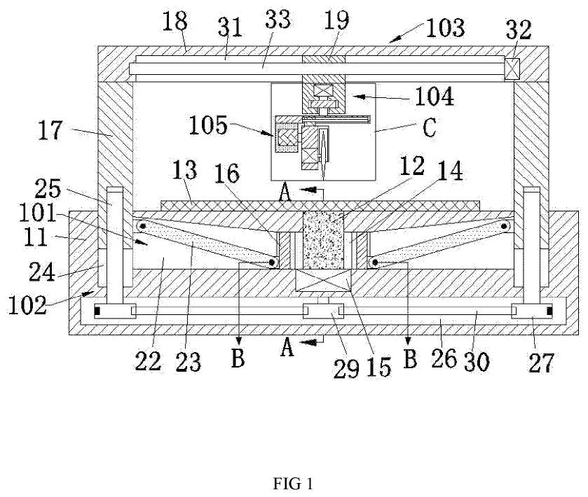

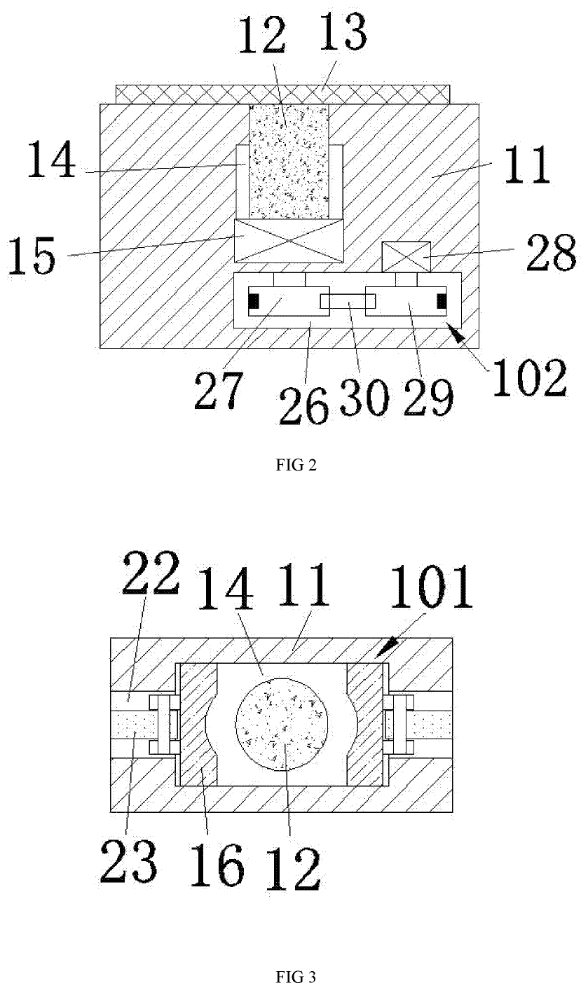

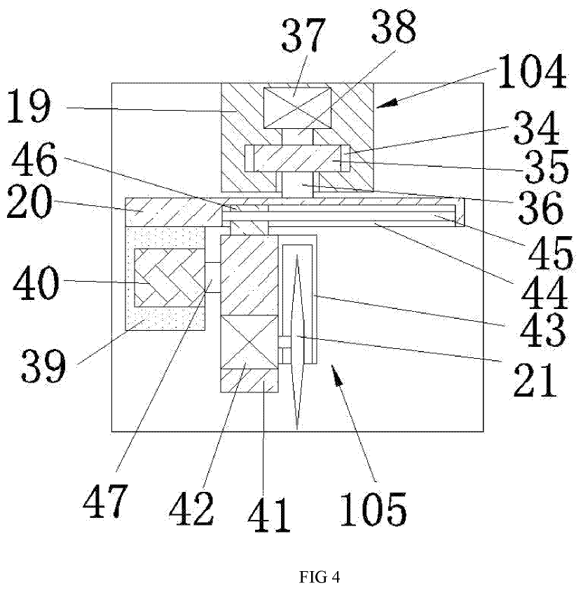

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself.

The invention relates to a multi-directional marble cutting apparatus, which is mainly used for cutting marble in the production of marble. The invention will be further described below with reference to the accompanying drawings of the invention:

The multi-directional marble cutting apparatus according to the present invention comprises a machine tool 11 which is provided with a rotating column 12 rotatable on the center of the upper end surface of the machine tool 11. A base 13 is fixed on the upper end of the rotating column 12. A clamping cavity 14 is provided in the center, and a steering motor 15 is fixed on the lower wall of the clamping cavity 14. The lower end of the rotating column 12 extends into the clamping cavity 14 and is dynamically connected to the upper end of the steering motor 15. A clamping device 101 is provided symmetrically in the clamping cavity 14 and on the left and right sides of the rotating column 12. A left-right symmetrical clamping plate 16 is provided in the clamping device 101. The left and right sides of the rotating column 12, after the steering motor 15 drives the base 13 to rotate through the required angle through the rotating column 12, the clamping plate 16 can clamp the left and right ends of the rotating column 12, and further During the cutting process, the stability of the base 13 is increased. The left and right sides of the machine tool 11 are provided with lifting devices 102. The lifting device 102 is provided with left and right symmetrical lifting posts 17, and the clamping plates 16 are connected. In the lifting pillar 17, when the lifting pillar 17 is lowered, the clamp The plate 16 is clamped, and a cross beam 18 is fixed at the upper end of the lifting pillar 17. A translation device 103 is provided in the translation block 19, and a translation block that can slide in the cross beam 18 is provided in the translation device 103. 19, a rotating device 104 is provided on the lower side of the translation block 19, and a rotating plate 20 is provided on the lower side of the translation block 19, and a cutting device 105 is provided on the lower side of the rotating plate 20, A saw blade 21 is provided in the cutting device 105.

Beneficially, the translation device 103 can drive the rotating plate 20 to move horizontally in the left-right direction through the translation block 19, and in combination with the turning of the base 13, rotate the cutting point directly below the beam 18. Then, move the saw blade 21 above the cutting point, and adjust the cutting direction of the saw blade 21 by rotating the rotating plate 20, and then perform fixed-point cutting of the marble. When strip cutting of the marble is required, turn the saw blade 21 The base 13 is such that the cutting direction is left-right and parallel to the cross beam 18. At this time, the rotating plate 20 is rotated so that the cutting direction of the saw blade 21 is left-right direction, and then the saw blade 21 is moved forward or backward to Above the cutting line, then the saw blade 21 is lowered for cutting, and at the same time, the translation block 19 is moved left and right to drive the saw blade 21 to move left and right for cutting.

According to the embodiment, the clamping device 101 will be described in detail below. The clamping device 101 includes symmetrical and connecting rod cavities 22 provided on the left and right walls of the clamping cavity 14. The clamping plate 16 is symmetrical on the left and right. Slidingly disposed in the clamping cavity 14, a side surface of the clamping plate 16 away from the rotating column 12 is hinged with a push-pull rod 23 located in the link cavity 22, and the push-pull rod 23 is away from One end of the clamping plate 16 is hingedly connected to the lower end of the end surface of the lifting pillar 17 near the center of symmetry.

According to the embodiment, the lifting device 102 will be described in detail below. The lifting device 102 includes a lifting cavity 24 symmetrically provided at the left and right ends in the machine tool 11 and opening upward. The lifting cavity 24 communicates with the connection on the same side. The rod cavity 22 is far from the clamping cavity 14. The lifting column 17 is slidably arranged in the lifting cavity 24. The lower wall of the lifting cavity 24 is rotatably provided with a screw connection in the lifting column 17. The lifting screw 25 is provided with a pulley cavity 26 below the lifting cavity 24, and the lower end of the lifting screw 25 extends into the pulley cavity 26 to be fixed with a driven pulley 27, the driven pulley 27 A driving belt pulley 29 is rotatably provided between the driving belt pulley 29 and the driven belt pulley 27.

Advantageously, a lifting motor 28 is fixed in the upper wall of the pulley cavity 26 and on the rear side of the steering motor 15, and the active pulley 29 is dynamically connected to the lower end of the lifting motor 28.

According to the embodiment, the translation device 103 is described in detail below. The translation device 103 includes a translation cavity 31 provided in the beam 18 and opening downward. A translation motor 32 is fixed in the right wall of the translation cavity 31. A translation screw 33 is dynamically connected to the left end of the translation motor 32, and the translation block 19 is slidably disposed in the translation cavity 31 and is threadedly connected to the translation screw 33.

According to the embodiment, the rotating device 104 is described in detail below. The rotating device 104 includes a turntable cavity 34 provided on the lower side of the translation block 19, and a turntable 35 is rotatably provided in the turntable cavity 34. The rotation center of the lower end surface of the rotating disk 35 is fixedly provided with a suspension post 36, the lower end of the suspension post 36 extends to the lower side of the translation block 19, and the rotating plate 20 is fixedly disposed at the lower end of the suspension post 36.

Beneficially, a rotary motor 37 is fixed in the upper wall of the turntable cavity 34, and a lower end of the rotary motor 37 is power-connected with a power shaft 38, and the lower end of the power shaft 38 is fixedly connected to the center of rotation of the upper end surface of the rotary disk 35.

According to the embodiment, the cutting device 105 will be described in detail below. The cutting device 105 includes a fixing block 39 fixedly provided on the left end of the lower end surface of the rotating plate 20, and a hydraulic pump 40 is fixed in the fixing block 39. The right end of the hydraulic pump 40 is hydraulically connected with a hydraulic telescopic arm 47. The right end of the hydraulic telescopic arm 47 is fixed with a moving block 41. A cutting motor 42 is fixed in the moving block 41. A right end of the moving block 41 is fixed with a half An annular dust shield 43, the saw blade 21 is disposed in the dust shield 43 and is dynamically connected to the right end of the cutting motor 42.

Beneficially, a guide slide cavity 44 with an opening downward is provided in the rotating plate 20 and on the right side of the fixing block 39. Guide slide rods 45 are fixedly connected between the left and right walls of the guide slide cavity 44. A slide block 46 slidably connected to the slide bar 45 is provided in the slide cavity 44. The lower end of the slide block 46 is fixedly connected to the upper end surface of the moving block 41.

The following describes in detail the use steps of a multi-directional marble cutting device in this article with reference to FIGS. 1 to 4:

At the beginning, the beam 18 is at the upper limit position, the clamping plate 16 is far from the rotating column 12, the saw blade 21 is directly below the suspension column 36, and the marble is fixedly placed on the base 13.

When performing fixed-point cutting, the steering motor 15 is activated, and the base 13 is rotated by the rotating column 12 to further point the marble to be cut directly below the beam 18. The translation motor 32 is started and the translation screw 33 is rotated, and the translation block is driven by the threaded connection. 19 moves, and then drives the saw blade 21 to directly above the cutting point. At this time, the rotary motor 37 is started, and the rotating plate 20 is rotated by the suspension column 36, thereby driving the saw blade 21 to rotate the cutting angle to the required cutting angle. At this time, the cutting motor 42 starts and drives the saw blade 21 to rotate at a high speed. At this time, the lifting motor 28 starts and drives the driving pulley 29 to rotate. The driven belt 27 is driven to rotate through the transmission belt 30 and the lifting screw 25 is driven to rotate. Then the lifting pillar 17 is lowered through the screw connection. And then drive the cross beam 18 to descend, at this time the saw blade 21 descends and cuts the marble, at this time, the lifting pillar 17 pushes the clamping plate 16 inwardly by pushing the pull rod 23 to abut the rotating column 12, and then clamps the rotating column 12;

When cutting the marble in a straight line, the steering motor 15 is activated and drives the base 13 to rotate, so that the marble is adjusted to the cutting line direction to the left and right. At this time, the rotary motor 37 is started to adjust the cutting direction of the saw blade 21 to the left and right. When the cutting line is directly below the saw blade 21, the cutting motor 42 and the lifting motor 28 are directly started. At this time, the saw blade 21 starts the cutting of the marble. At this time, the translation motor 32 starts and drives the translation block 19 to move left and right, thereby driving the saw. The blade 21 moves left and right, so that the marble is cut left and right in a straight line. When the cutting line is located at the front or rear side of the saw blade 21, the hydraulic pump 40 is activated, and the hydraulic block 47 pushes the moving block 41 to move forward or backward, so that the saw blade 21 is directly above the cutting line, and then the marble is cut straight.

The beneficial effect of the present invention is that by adjusting the position and direction of the marble and the cutting tool, the present invention can perform fixed-point and arbitrary angle cutting on any position of the marble, and can also perform linear cutting on any linear position of the marble to meet more cutting process requirements. And, when cutting, the base is clamped firmly to avoid displacement during cutting and torsion to the cutter, causing damage or cutting accidents.

In the above manner, those skilled in the art can make various changes according to the working mode within the scope of the present invention.

1. A multi-directional marble cutting apparatus includes a machine tool, a center of the upper end surface of the machine tool is rotatably provided with a rotation column, a base of the rotation column is fixedly provided with a base, a center of the machine tool is provided with a clamping cavity, and the clamp A steering motor is fixed on the lower wall of the cavity, and the lower end of the rotating column extends into the clamping cavity and is dynamically connected to the upper end of the steering motor;
Clamping devices are symmetrically provided in the clamping cavity and on the left and right sides of the rotating column. The clamping devices are provided with left and right symmetrical clamping plates. The clamping plates are located on the left and right sides of the rotating column. After the steering motor drives the base to rotate through the required angle through the rotating column, the clamping plate may clamp the left and right ends of the rotating column, thereby increasing the stability of the base during the cutting process. Sex Lifting devices are provided on the left and right sides of the machine tool. The lifting devices are provided with lifting columns that are symmetrical to the left and right. The clamping plate is connected to the lifting column. When the lifting column is lowered, the clamping plate Then clamping; a cross beam is fixed at the upper end of the lifting pillar, a translation device is provided in the translation block, a translation block is slidable in the cross beam, and a rotation device is arranged in the lower side of the translation block. The rotating device is provided with a rotating plate located on the lower side of the translation block, a cutting device is provided on the lower side of the rotating plate, and a saw blade is provided in the cutting device.

2. The multi-directional marble cutting apparatus according to claim 1, wherein the translation device can drive the rotary plate to move horizontally in the left-right direction through the translation block, and at the same time combined with the turning of the base, the The cutting point needs to be rotated directly below the cross beam, and then the saw blade is moved above the cutting point. By rotating the rotating plate, the cutting direction of the saw blade is adjusted to further cut the marble at a fixed point. When performing bar cutting, rotate the base so that the cutting direction is left and right, parallel to the beam. At this time, rotate the rotating plate so that the cutting direction of the saw blade is left and right, and then move the saw blade forward or backward. It then moves above the cutting line, then lowers the saw blade for cutting, and at the same time, the translation block moves left and right to drive the saw blade to move left and right to cut.

3. The multi-directional marble cutting apparatus according to claim 1, wherein the clamping device comprises symmetrical and connecting rod cavities provided on the left and right walls of the clamping cavity, and the clamping plate is symmetrical on the left and right sides. And slidably disposed in the clamping cavity, and the end surface of one side of the clamping plate far from the rotating column is hinged with a push-pull rod located in the link cavity, and the push-pull rod is far from the clamping plate One end of the hinge is connected to the lower end of the end surface of the lifting pillar near the center of symmetry.

4. The multi-directional marble cutting apparatus according to claim 1, wherein the lifting device comprises a lifting cavity which is symmetrically arranged at the left and right ends in the machine tool and has an upward opening, and the lifting cavity is connected to the same side. The connecting rod cavity is far from the clamping cavity, the lifting pillar is slidably arranged in the lifting cavity, and the lower wall of the lifting cavity is rotatably provided with a lifting screw screwed into the lifting pillar; the lower side of the lifting cavity is provided with a pulley cavity, and the lower end of the lifting screw extends into the pulley cavity to be fixed with a driven pulley, and a driven pulley is rotatably provided between the driven pulleys. A transmission belt is wound between the driving pulley and the driven pulley.

5. The multi-directional marble cutting apparatus according to claim 4, characterized in that: a lifting motor is fixed in the upper wall of the pulley cavity and behind the steering motor, and the active pulley is dynamically connected to the The lower end of the lifting motor is described.

6. The multi-directional marble cutting apparatus according to claim 1, wherein the translation device comprises a translation cavity provided in the beam and opening downward, and a translation motor is fixedly located in the right wall of the translation cavity. A translation screw is dynamically connected to the left end of the translation motor, and the translation block is slidably arranged in the translation cavity and is threadedly connected to the translation screw.

7. The multi-directional marble cutting apparatus according to claim 1, wherein the rotating device comprises a turntable cavity provided on the lower side inside the translation block, and a turntable is rotatably provided in the turntable cavity. A suspension column is fixed at the rotation center of the lower end surface of the rotating disk, the lower end of the suspension column extends to the lower side of the translation block, and the rotating plate is fixedly disposed at the lower end of the suspension column.

8. The multi-directional marble cutting apparatus according to claim 7, characterized in that: a rotary motor is fixed in the upper wall of the turntable cavity, a power shaft is connected to the lower end of the rotary motor, and a lower end of the power shaft is fixedly connected Centered on the upper end surface of the rotating disk.

9. The multi-directional marble cutting apparatus according to claim 1, wherein the cutting device comprises a fixing block fixedly arranged at the left end of the lower end face of the rotating plate, and a hydraulic pump is fixedly installed in the fixing block. The right end of the hydraulic pump is hydraulically connected with a hydraulic telescopic arm. A moving block is fixed at the right end of the hydraulic telescopic arm. A cutting motor is fixed in the moving block, a semi-circular-shaped dust block is fixed at the right end of the moving block. Plate, the saw blade is disposed in the dust blocking plate and is dynamically connected to the right end of the cutting motor.

10. The multi-directional marble cutting apparatus according to claim 9, characterized in that: in the rotating plate and on the right side of the fixed block, guide sliding chambers with downward openings are provided. A guide slider is fixedly connected between the guide sliders, and a guide slider slidingly connected to the guide slider is slidably provided in the guide sliding cavity, and the lower end of the guide slider is fixedly connected to the upper end surface of the moving block.
